(19) United States
(12) Patent Application Publication
(10) Pub. No.: US 2004/0165077 A1
(43) Pub. Date: Aug. 26, 2004

(54) Digital camera having separable user module

(75) Inventor: Seishi Ohmori, Seongnam-si (KR)

Correspondence Address: GARDNER CARTON & DOUGLAS LLP, ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 10/786,783

(22) Filed: Feb. 25, 2004

(30) Foreign Application Priority Data
Feb. 26, 2003 (KR) 2003-11952

(51) Int. Cl. H04N 5/232

(52) U.S. Cl. 348/211.2

(57) ABSTRACT

A digital camera includes a user module that can be separated from a main body of the digital camera. The user module includes a wired communication interface, a wireless communication interface, a user input unit, a display device, and a controller. The main body also includes a wired communication interface and a wireless communication interface corresponding to the wired communication interface and the wireless communication interface, respectively, of the user module. A digital image signal from a digital signal processor of the main body is transmitted to the user module through the wired or wireless communication interfaces and then displayed on the display device of the user module. A user input signal input through the user input unit of the user module is transmitted to the digital signal processor of the main body through the wired or wireless communication interfaces and then processed by the digital signal processor. An audio signal is input to the controller of the user module through an analog-to-digital converter, then transmitted to the digital signal processor through the communication interfaces of the user module and the main body.

This application claims priority to Korean Patent Application No. 200311952, filed on Feb. 26, 2003, in the Korean Intellectual Property Office, the disclosure of which is incorporated herein in its entirety by reference.

### FIELD OF THE INVENTION

The present invention relates to a digital camera, more particularly a digital camera which includes an optical system, an optoelectric converter, an analog-to-digital converter, and a digital signal processor in its main body.

### BACKGROUND

A typical modern digital camera, for example, Digimax 350SE™ of Samsung Techwin™, includes a remote control. However, such a remote control can only generate a shutter control signal, thereby requiring a user to approach the main body of a camera to check and adjust various photographic states and conditions before and after operating the camera using the remote control.

Past devices, such as those disclosed in U.S. Pat. No. 4,420,773 and U.S. Pat. No. 6,393,216, include remote devices with some additional capabilities. However, neither discloses a digital camera with detachable remote device that is capable of, for example, utilizing a digital signal processor or processing audio signals. Therefore, it is beneficial to provide a digital camera with a detachable remote device that is capable of handling these features.

### SUMMARY OF THE INVENTION

The present invention provides a digital camera which allows a user to check and adjust various photographic states and conditions without approaching the main body of the digital camera when using the digital camera.

According to an aspect of the present invention, there is provided a digital camera including a main body and a user module which can be separated from the main body. The main body includes an optical system including a plurality of lenses to optically process light from a subject, an optoelectric converter converting the light from the optical system into an electric analog image signal, an analog-to-digital converter converting the analog image signal of the optoelectric converter into a digital image signal, a digital signal processor processing the digital image signal from the analog-to-digital converter to provide it to a user, a wired communication interface, and a wireless communication interface. The user module includes a wired communication interface and a wireless communication interface, which respectively correspond to the wired communication interface and the wireless communication interface of the main body, a user input unit, a display device, and a controller. A digital image signal of the digital signal processor is transmitted to the user module through the wired or wireless communication interfaces and is displayed on the display device of the user module. A user input signal input through the user input unit of the user module is transmitted to the digital signal processor through the wired or wireless communication interfaces and is processed by the digital signal processor. An audio signal is input to the controller of the user module through an analog-to-digital converter, then transmitted to the digital signal processor through the communication interfaces of the user module and the main body.

Accordingly, a user can check and adjust various photographic states and conditions without approaching the main body of the digital camera by using a user module.

### BRIEF DESCRIPTION OF THE DRAWINGS

The above and other features and advantages of the present invention will become more apparent by describing in detail preferred embodiments thereof with reference to the attached drawings in which:

FIG. 1 is a front view of a digital camera into which a user module is inserted, according to the present invention;

FIG. 2 is a rear view of the digital camera shown in FIG. 1;

FIG. 3 is a diagram showing a state in which a front panel of the user module inserted into the digital camera shown in FIG. 2 is open;

FIG. 4 is a diagram showing a state in which the user module is separated from the digital camera shown in FIG. 2;

FIG. 5 is a block diagram showing an internal structure of the digital camera shown in FIG. 2; and

FIG. 6 is a block diagram showing an internal structure of the user module shown in FIG. 2.

### DETAILED DESCRIPTION OF THE INVENTION

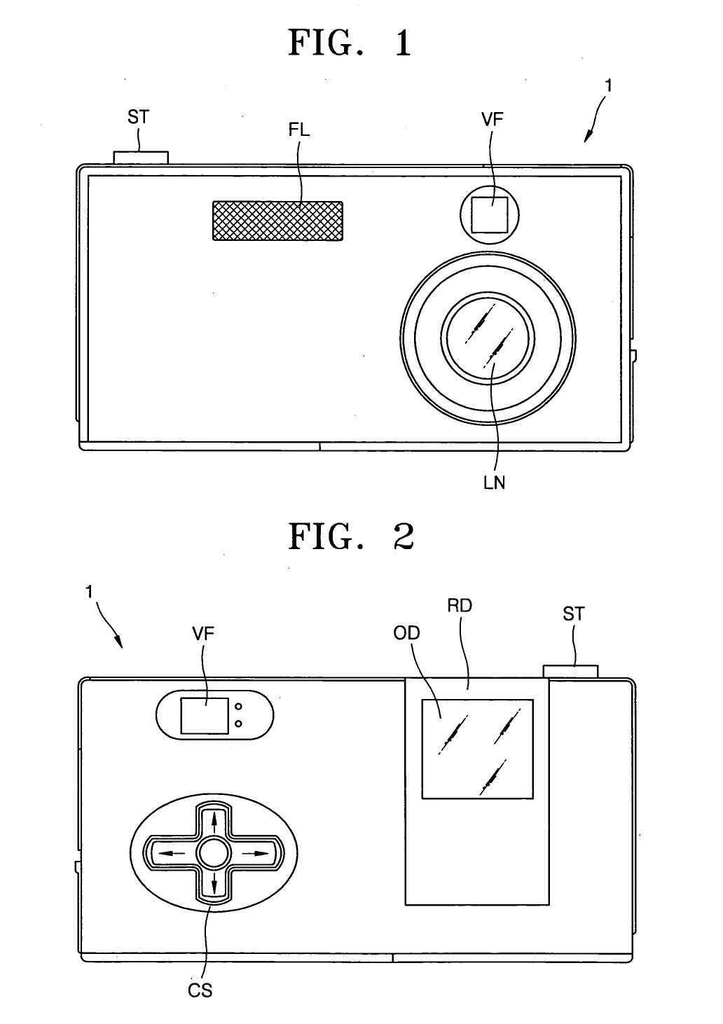

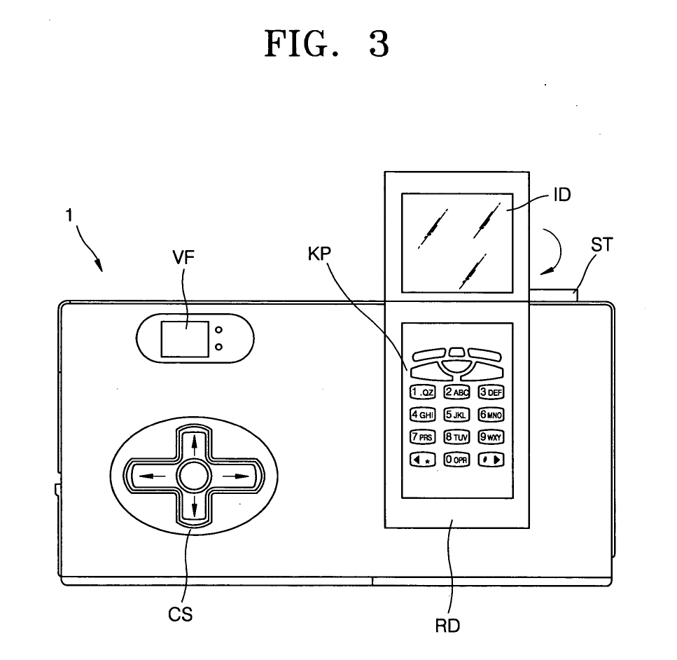

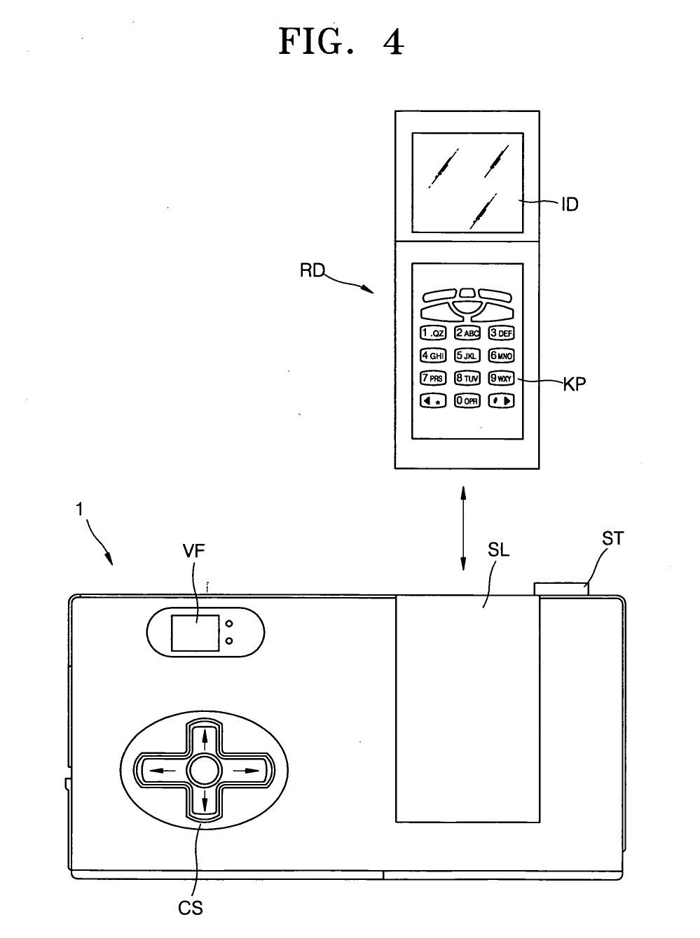

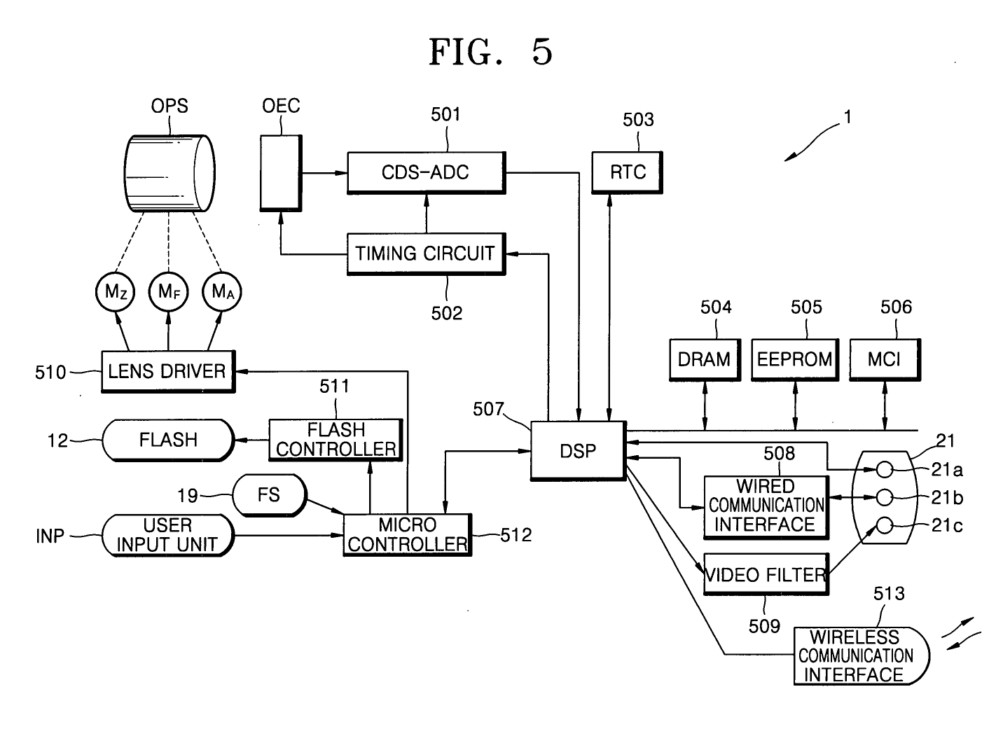

FIG. 1 shows the front side of a main body 1 of a digital camera into which a user module RD is inserted, according to the present invention. FIG. 2 shows the back of the main body 1 shown in FIG. 1. FIG. 3 shows a state in which a front panel of the user module RD inserted into the main body 1 shown in FIG. 2 is open. FIG. 4 shows a state in which the user module RD is separated from the main body 1 shown in FIG. 2.

Referring to FIGS. 1 through 4, the main body 1 of a digital camera includes a shutter ST, a flash FL, a view finder VF, a lens unit LN, and a control input unit CS. The user module RD includes an external display panel OD provided on the front side of the front panel, an internal display panel ID provided on the rear side of the front panel, and a keypad KP.

Each of the main body 1 and the user module RD includes a communication interface so that a digital image signal of the main body 1 is displayed on the internal display panel ID of the user module RD, and a user input signal of the user module RD is processed by the main body 1. Since the main body 1 can secure a space for the user module RD, the user module RD can be used after being inserted into a slot SL of the main body 1. The user module RD can also be used after being separated from the main body 1. When the user module RD is inserted into the main body 1, a wired communication interface provided in the slot SL of the main body 1 is connected to a wired communication interface provided in the user module RD. When the user module RD is separated from the main body 1, a wireless communication interface of the main body 1 and a wireless communication interface of the user module RD operate. The interface between the main body 1 and the user module RD will be described in detail later.

Hereinafter, the structure and operation of the main body 1 shown in FIG. 5 will be described with reference to FIGS. 1 through 6.

An optical system OPS, including the lens unit LN and a filter unit, optically processes light from a subject. The lens unit LN of the optical system OPS includes a zoom lens, a focus lens, and a compensating lens.

An optoelectric converter OEC implemented by one of a charge coupled device (CCD) and a complementary metal-oxide-semiconductor (CMOS) converts light from the optical system OPS into an electric analog image signal. Here, a digital signal processor (DSP) 507 controls a timing circuit 502 to control the optoelectric converter OEC and a correlation double sampler and analog-to-digital converter (CDS-ADC) 501. The CDS-ADC 501 processes an analog image signal received from the optoelectric converter OEC to remove high-frequency noise, adjusts the amplitude, and then converts the analog image signal into a digital image signal. The DSP 507 processes the digital image signal received from the CDS-ADC 501 to generate a luminance signal and a chrominance signal.

The digital image signal including the luminance and chrominance signals transmitted from the DSP 507 is temporarily stored in a dynamic random access memory (DRAM) 504. An algorithm and setup data which are necessary for the operation of the DSP 507 are stored in an electrically erasable programmable read only memory (EEPROM) 505. A user's memory card is removably installed in a memory card interface (MCI) 506. The MCI 506 stores still or moving image files and audio files, which are compressed by the DSP 507.

A user input unit INP includes the control input unit CS and a shutter button ST.

A micro-controller 512 controls a lens driver 510 such that a zoom motor M_{z}, a focus motor M_{F}, and an aperture motor MA drive the zoom lens, the focus lens, and aperture, respectively, included in the optical system OPS. The micro-controller 512 also controls a flash controller 511 according to a signal received from a flash sensor (FS) 19 to drive a flash 12.

The digital image signal from the DSP 507 can be transmitted using serial communication via a universal serial bus (USB) connector 21a or can be transmitted as a video signal via a video filter 509 and a video output unit 21c. The digital image signal from the DSP 507 can also be transmitted through a wired communication interface 508 to the user module RD and a connector 21b, or transmitted through a wireless communication interface 513 to the user module RD. As described above, when the user module RD is inserted into the main body 1, the wired communication interface 508 provided in the slot SL of the main body 1 is connected to a wired communication interface 608 included in the user module RD. When the user module RD is separated from the main body 1, communication is performed through the wireless communication interface 513 of the main body 1 and a wireless communication interface 609 of the user module RD. Here, one of a “Bluetooth” and a “IEEE802.11b” protocol, both of which are well known wireless communication protocols, may be used.

The digital image signal of the DSP 507 is input to a controller 610 of the user module RD via the wired communication interfaces 508 and 608 of the main body 1 and the user module RD, respectively, or the wireless communication interfaces 513 and 609 thereof. The controller 610 of the user module RD processes the digital image signal and drives a display device 606 of the user module RD. Accordingly, the digital image signal of the DSP 507 is displayed on the internal display panel ID of the user module RD.

A user input signal, which is input using the keypad KP included in a user input unit 607 of the user module RD to the controller 610, is transmitted from the controller 610 of the user module RD to the DSP 507 through the wired communication interfaces 608 and 508 of the user module RD and the main body 1, respectively, or the wireless communication interfaces 609 and 513 thereof, and is than processed by the DSP 507. For example, each part of the main body 1 can be operated according to a user command signal input to the controller 610 of the user module RD. In addition, a voice or audio signal input through a microphone MIC of the user module RD can be stored in a memory card inserted into the MCI 506 of the main body 1.

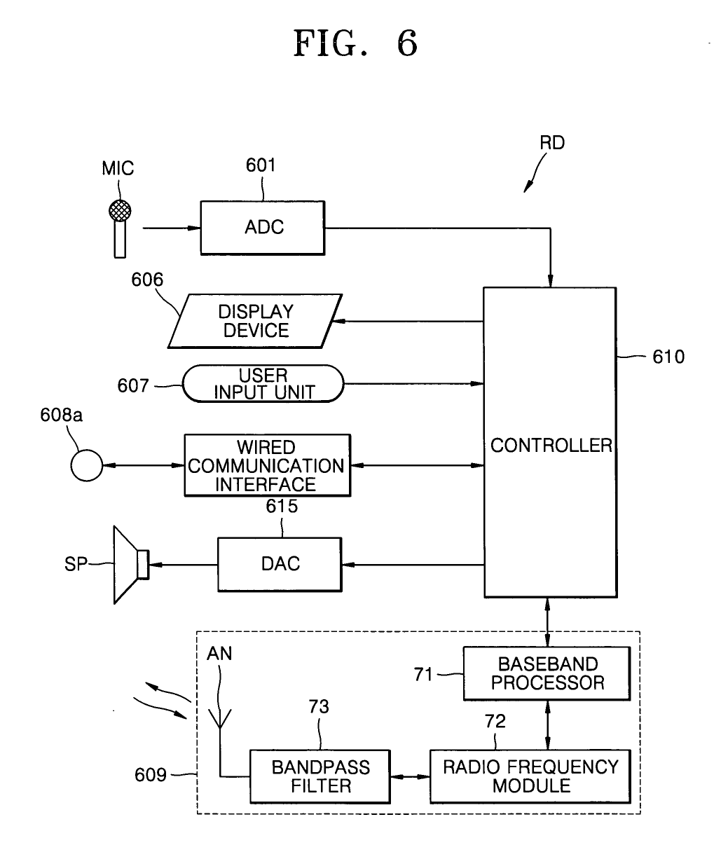

Hereinafter, the structure and operation of the user module RD shown in FIG. 6 will be described in detail with reference to FIGS. 1 through 6.

The user module RD includes a microphone MIC, analog-to-digital converter (ADC) 601, a display device 606, a user input unit 607 including a keypad (KP shown in FIGS. 3 and 4), a wired communication interface 608 with a connector 608a, a wireless communication interface 609, a controller 610, a digital-to-analog converter (DAC) 615, and a speaker SP.

The display device 606 is controlled by the controller 610 and includes a display driver, an external display panel OD (shown in FIG. 2), and an internal display panel ID (shown in FIG. 3). The display device 606 displays a signal from the user input unit 607 and a digital image signal received through the connector 608a and the wired communication interface 608 or through the wireless communication interface 609.

The wireless communication interface 609 includes a baseband processor 71, a radio frequency module 72, a bandpass filter 73, and a transmit/receive antenna AN. The baseband processor 71 converts the frequency of a user input signal and the frequency of a voice signal received from the controller 610 into a radio frequency and outputs the radio frequency to the radio frequency module 72. In addition, the baseband processor 71 converts the frequency of an image signal received from the radio frequency module 72 into a baseband frequency and outputs the baseband frequency to the controller 610. The radio frequency module 72 processes the radio frequency received from the baseband processor 71 and outputs the processed radio frequency to the bandpass filter 73. The radio frequency module 72 also processes a radio frequency received from the bandpass filter 73 and outputs the processed radio frequency to the baseband processor 71. The bandpass filter 73 passes only signals having a particular band frequency among transmission signals received from the radio frequency module 72 to the transmit/receive antenna AN. The bandpass filter 73 also passes only image signals having the predetermined band frequency among reception signals from the transmit/receive antenna AN to the radio frequency module 72.

When the user module RD is inserted into the slot SL of the main body 1, a digital image signal transmitted through the wired communication interface 508 and the connector 21b of the main body 1 is input to the controller 610 through the connector 608a and the wired communication interface 608. When the user module RD is separated from the main body 1, the digital image signal transmitted through the wireless communication interface 513 of the main body 1 is input to the controller 610 through the wireless communication interface 609 of the user module RD. Then, the controller 610 displays the digital image signal from the main body 1 on the display device 606.

In addition, the controller 610 transmits signals, e.g., a camera command signal among user input signals received through the user input unit 607 to the main body 1 through the wired communication interface 608 or the wireless communication interface 609 so that the signals can be processed by the main body 1.

Meanwhile, the ADC 601 converts an analog voice signal received from the microphone MIC into a digital voice signal and outputs the digital voice signal to the controller 610. When the user module RD is inserted into the slot SL of the main body 1, a voice signal received from the microphone MIC is controlled by the controller 610 to be output through the wired communication interface 608 and the connector 608a and then is input to the DSP 507 through the connector 21b and the wired communication interface 508 of the main body 1. When the user module RD is separated from the main body 1, a voice signal from the microphone MIC is controlled by the controller 610 to be output through the wireless communication interface 609 and is then input to the DSP 507 through the wireless communication interface 513 of the main body 1. Then, the DSP 507 stores the voice signal in the memory card through the MCI 506. Here, a voice file can be formed to be linked to an image file.

Meanwhile, a digital voice signal stored in the memory card of the main body 1 can be transmitted to the controller 610 of the user module RD. The digital voice signal transmitted to the controller 610 is converted into an analog signal by the DAC 615 and then reproduced through the speaker SP.

As described above, according to a digital camera of the present invention, a user can check and adjust various photographic states and conditions without approaching a main body of the digital camera by using a user module.

Although a few embodiments of the present invention have been shown and described, it will be appreciated by those skilled in the art that changes may be made in these elements without departing from the principles and spirit of the invention, the scope of which is defined in the appended claims and their equivalents.

What is claimed is:

1. A digital camera system comprising:
a main body that comprises an optical system including a plurality of lenses to optically process light from a subject, an optoelectric converter converting the light from the optical system into an electrical analog image signal, an analog-to-digital converter converting the analog image signal of the optoelectric converter into a digital image signal, a digital signal processor processing the digital image signal from the analog-to-digital converter, and a wireless communication interface; and
a user module that comprises a wireless communication interface, which corresponds to the wireless communication interface of the main body, a user input unit, a display device, and a controller,
wherein a digital image signal of the digital signal processor may be transmitted to the user module through the wireless communication interface and displayed on the display device of the user module, and
a user input signal input through the user input unit of the user module may be transmitted to the digital signal processor through the wireless communication interface and processed by the digital signal processor.

2. The digital camera system of claim 1,
wherein the user module is connectable to and separable from the main body, the main body further comprises a wired communication interface, and the user module further comprises a wired communication interface that corresponds to the wired communication interface of the main body,
wherein the digital image signal of the digital signal processor may be transmitted to the user module through the wired communication interface, and
wherein the user input signal input through the user input unit of the user module may be transmitted to the digital signal processor through the wired communication interface.

3. The digital camera system of claim 2, wherein the main body further comprises a slot into which the user module is inserted, and when the user module is inserted into the slot, the wired communication interface of the user module is connected to the wired communication interface of the main body.

4. The digital camera system of claim 3, wherein when the user module is separated from the slot, the digital signal processor and the controller of the user module communicate with each other through the wireless communication interface of the main body and the wireless communication interface of the user module.

5. The digital camera system of claim 1, wherein the digital image signal of the digital signal processor is input to the controller of the user module through the communication interfaces of the main body and the user module and is controlled by the controller of the user module to be input to and displayed on the display device of the user module.

6. The digital camera system of claim 1, wherein the user input signal is input through the user input unit of the user module to the controller of the user module, then transmitted to the digital signal processor through the communication interfaces of the user module and the main body, and then processed by the digital signal processor.

7. The digital camera system of claim 1, wherein the user module further comprises a microphone and an analog-to-digital converter.

8. The digital camera system of claim 7, wherein an audio signal of the microphone is input to the controller of the user module through the analog-to-digital converter, then transmitted to the digital signal processor through the communication interfaces of the user module and the main body.

9. The digital camera system of claim 8, wherein the audio signal is stored in a recording medium by the digital signal processor.

10. The digital camera system of claim 1, wherein the user module further comprises a digital-to-analog converter and a speaker.

11. The digital camera system of claim 10, wherein an audio signal stored in the recording medium is transmitted by the digital signal processor through the communication interfaces of the main body and the user module to the controller of the user module and then output through the digital-to-analog converter and the speaker by the controller.

12. The digital camera system of claim 2, wherein the digital image signal of the digital signal processor is input to the controller of the user module through the communication interfaces of the main body and the user module and is controlled by the controller of the user module to be input to and displayed on the display device of the user module, and
wherein the user input signal is input through the user input unit of the user module to the controller of the user module, then transmitted to the digital signal processor through the communication interfaces of the user module and the main body, and then processed by the digital signal processor.

13. A digital camera system comprising:
a main body that comprises an optical system including a plurality of lenses to optically process light from a subject, an optoelectric converter converting the light from the optical system into an electrical analog image signal, an analog-to-digital converter converting the analog image signal of the optoelectric converter into a digital image signal, a digital signal processor processing the digital image signal from the analog-to-digital converter, and a wireless communication interface; and
a user module that comprises a wireless communication interface, which corresponds to the wireless communication interface of the main body, a user input unit, a display device, a controller, a microphone, an analog-to-digital converter, a digital-to-analog converter, and a speaker,
wherein a digital image signal of the digital signal processor may be transmitted to the user module through the wireless communication interface and displayed on the display device of the user module, and
a user input signal input through the user input unit of the user module may be transmitted to the digital signal processor through the wireless communication interface and processed by the digital signal processor,
wherein the user module is connectable to and separable from the main body, the main body further comprises a wired communication interface, and the user module further comprises a wired communication interface that corresponds to the wired communication interface of the main body,
wherein the digital image signal of the digital signal processor may be transmitted to the user module through the wired communication interface, and
wherein the user input signal input through the user input unit of the user module may be transmitted to the digital signal processor through the wired communication interface.

14. The digital camera system of claim 13, wherein the main body further comprises a slot into which the user module is inserted, and when the user module is inserted into the slot, the wired communication interface of the user module is connected to the wired communication interface of the main body.

15. The digital camera system of claim 14, wherein when the user module is separated from the slot, the digital signal processor and the controller of the user module communicate with each other through the wireless communication interface of the main body and the wireless communication interface of the user module.

16. The digital camera system of claim 13, wherein the digital image signal of the digital signal processor is input to the controller of the user module through the communication interfaces of the main body and the user module and is controlled by the controller of the user module to be input to and displayed on the display device of the user module.

17. The digital camera system of claim 13, wherein the user input signal is input through the user input unit of the user module to the controller of the user module, then transmitted to the digital signal processor through the communication interfaces of the user module and the main body, and then processed by the digital signal processor.

18. The digital camera system of claim 13, wherein an audio signal of the microphone is input to the controller of the user module through the analog-to-digital converter, then transmitted to the digital signal processor through the communication interfaces of the user module and the main body.

19. The digital camera system of claim 18, wherein the audio signal is stored in a recording medium by the digital signal processor.

20. The digital camera system of claim 13, wherein an audio signal stored in the recording medium is transmitted by the digital signal processor through the communication interfaces of the main body and the user module to the controller of the user module and then output through the digital-to-analog converter and the speaker by the controller.
